(19) United States
(12) Patent Application Publication
(10) Pub. No.: US 2010/0162048 A1
(43) Pub. Date: Jun. 24, 2010

(54) APPARATUS AND METHOD FOR AUTOMATIC SELF-DIAGNOSIS USING UNIVERSAL SERIAL BUS PORT IN DIGITAL EQUIPMENT

(75) Inventor: Seung-Hak PAEK, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/638,191

(22) Filed: Dec. 15, 2009

(30) Foreign Application Priority Data
Dec. 24, 2008 (KR) 10-2008-0133061

(51) Int. Cl. G06F 11/07

(52) U.S. Cl. 714/37; 714/E11.029

(57) ABSTRACT

An apparatus and a method for automatically performing self-diagnosis are provided. In the method, when an external storage unit is connected, files stored in the external storage unit are searched for. When a diagnosis file for self diagnosis is stored in the external storage unit, information of at least one item required by the diagnosis file is collected. The collected information is stored as an output file in the external storage unit.

### PRIORITY

This application claims the benefit under 35 U.S.C. §119(a) of a Korean patent application filed in the Korean Intellectual Property Office on Dec. 24, 2008 and assigned Serial No. 10-2008-0133061, the entire disclosure of which is hereby incorporated by reference.

### BACKGROUND OF THE INVENTION

1. Field of the Invention

The present invention relates to digital equipment. More particularly, the present invention relates to an apparatus and a method for automatically performing self diagnosis using a Universal Serial Bus (USB) port in digital equipment.

2. Description of the Related Art

Presently, numerous types of digital equipment are used for convenience in everyday life or business. For example, Personal Computers (PCs), various communication equipment such as routers, switches, etc. and multimedia equipment such as Digital Versatile Disk (DVD) players, digital audio players, etc. are in use.

While digital equipment is used, a malfunction operation may occur due to various reasons, such as a user's erroneous use, a physical defect, a malfunction of software, and the like. To diagnose the malfunction, most digital equipment provides a self-diagnosis function, but use of the self-diagnosis function differs depending on the type of equipment and selection of an equipment manufacturer. That is, contents of diagnosis functions built-in each equipment are similar, but interfaces between input and output for performing the diagnosis function may be different, and a user who intends to execute the diagnosis function needs to know the methods for diagnosis corresponding to respective equipment, or needs to learn the methods for diagnosis using a manual.

When equipment operates without a problem, a user does not need to pay attention to diagnosis, but when a malfunction occurs, the user desires to detect the disorder and take measures to promptly mitigate the malfunction. However, when there is no specialist who can deal with the malfunction of the equipment on the spot, it is difficult to promptly take such measures. In this case, a user seeks out assistance through a telephone conversation with a specialist for assistance with measures to mitigate the malfunction. When the measures taken by the user do not resolve the malfunction, the specialist should take measures to mitigate the malfunction in person. Therefore, in the case where numerous equipment operates in different places, even though the equipment has an excellent diagnosis function, when a malfunction occurs, a measure to mitigate the malfunction cannot be promptly taken. Therefore, an alternative for diagnosing digital equipment needs to be proposed.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for swiftly diagnosing a state of digital equipment.

Another aspect of the present invention is to provide an apparatus and a method for performing a state diagnosis even when a user is not familiar with a diagnosis function in digital equipment.

Still another aspect of the present invention is to provide an apparatus and a method for performing an automatic self diagnosis using a USB port in digital equipment.

In accordance with an aspect of the present invention, a method for operating digital equipment which is capable to connect to an external storage unit is provided. The method includes when the external storage unit is connected, searching for files stored in the external storage unit, when a diagnosis file for self diagnosis is stored in the external storage unit, collecting information of at least one item required by the diagnosis file, and storing the collected information as an output file in the external storage unit.

In accordance with another aspect of the present invention, an apparatus for digital equipment which is capable to connect to an external storage unit is provided. The apparatus includes a processor for searching for files stored in the external storage unit when the external storage unit is connected, and an execution unit for, when a diagnosis file for self diagnosis is stored in the external storage unit, collecting information for at least one item required by the diagnosis file, wherein the processor stores the collected information as an output file in the external storage unit.

In accordance with still another aspect of the present invention, a digital equipment apparatus is provided. The apparatus includes an external connection port, a connection manager, a file processor, and a self diagnosis execution unit. The external connection port connects to an external storage unit. The connection manager determines if an external storage unit is connected to the external connection port, and if the connection manager determines that an external storage unit is connected to the external connection port, informs the file processor that the external storage unit is connected to the external connection port. The file processor, when being informed by the connection manager that the external storage unit is connected to the external connection port, searches for a diagnosis file stored in the external storage unit, when the diagnosis file is found in the external storage unit, sends the diagnosis file to the self diagnosis execution unit, generates an output file, and records information provided by the self diagnosis execution unit in the output file. The self diagnosis execution unit performs self diagnosis of the apparatus based on the diagnosis file received from the file processor, collects information resulting from the self diagnosis of the apparatus, and provides the collected information to the file manager.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a conceptual view illustrating a process for performing a self-diagnosis function in digital equipment according to an exemplary embodiment of the present invention;

FIG. 2 is a flowchart illustrating a self-diagnosis procedure in digital equipment according to an exemplary embodiment of the present invention; and

FIG. 3 is a block diagram illustrating digital equipment according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for diagnosing a state of digital equipment even when a user is not familiar with a diagnosis function of the digital equipment. In the following description, the digital equipment denotes equipment having a processor, operating according to a program code, and processing digital data. For example, the digital equipment may denote Personal Computers (PCs), communication equipment such as routers, switches, etc. and multimedia equipment such as Digital Versatile Disk (DVD) players, digital audio players, etc.

Exemplary embodiments of the present invention propose a technique for performing automatic self diagnosis using an input/output port used for connection of an external unit. Here, the input/output port may support a plug-and-play function, and preferably, may receive and output a file. For example, a Universal Serial Bus (USB) port may be used in an exemplary embodiment of the present invention. Hereinafter, an automatic self diagnosis technique is described on the assumption that digital equipment includes the USB port.

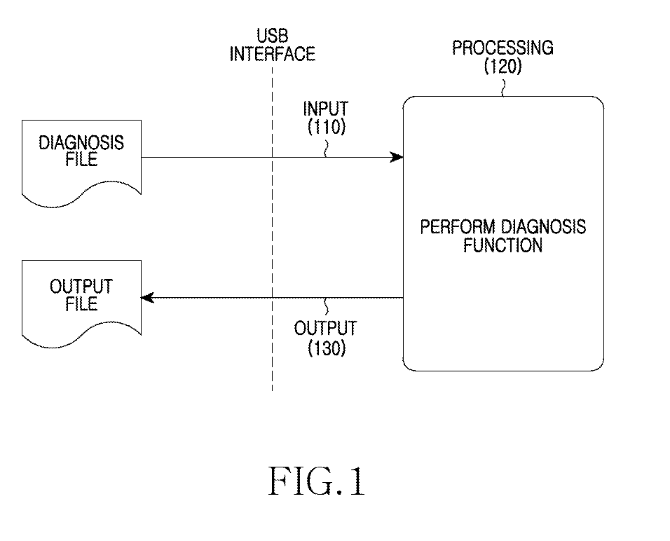

FIG. 1 is a conceptual view illustrating a process for performing a self-diagnosis function in digital equipment according to an exemplary embodiment of the present invention.

Referring to FIG. 1, self diagnosis according to an exemplary embodiment of the present invention is performed in the order of an input step 110, a processing step 120, and an output step 130.

Referring to the input step 110, a diagnosis file inside a USB storage unit may be input to the digital equipment via an USB interface. That is, the USB storage unit may store the file for diagnosis. The diagnosis file may be provided in advance. The input of the diagnosis file may be recognized as a command of self diagnosis. Alternatively, the command of self diagnosis may be generated through another action, such as the actuation of a key on the digital equipment. At this point, contents of the file may differ depending on specific diagnosis contents. For example, the file may include program code for extracting information regarding at least one item of a hardware version, a firmware version, a software version, a hardware device status, a function status, system statistics, alarm information, log information, operation history, debug information, etc. At this point, a diagnosis file for extracting items combined according to a purpose of diagnosis may be used. That is, a diagnosis file including items such as basic diagnosis, security diagnosis, and the like may be selected depending on an intention of the digital equipment manufacturer or a user, may be used.

When the digital equipment recognizes the input 110 via the USB interface, the diagnosis function may be performed in step 120. That is, the digital equipment may load a diagnosis file from the USB storage unit, and may collect information of an item required by the diagnosis file. In addition, in the output step 130, the collected information may be stored in an output file generated in the USB storage unit. That is, the digital equipment may generate the output file in the USB storage unit, and may record the collected information in the output file. At this point, since procedures after the diagnosis file input are performed as a hook function, they may be sequentially performed upon input of the diagnosis file without an additional command. Here, in the output step 130, when the digital equipment has a built-in memory for storing a file, the digital equipment may not directly generate the file in the USB storage unit, but may generate the output file in the built-in memory, record the collected information in the output file, and then transmit the output file to the USB storage unit.

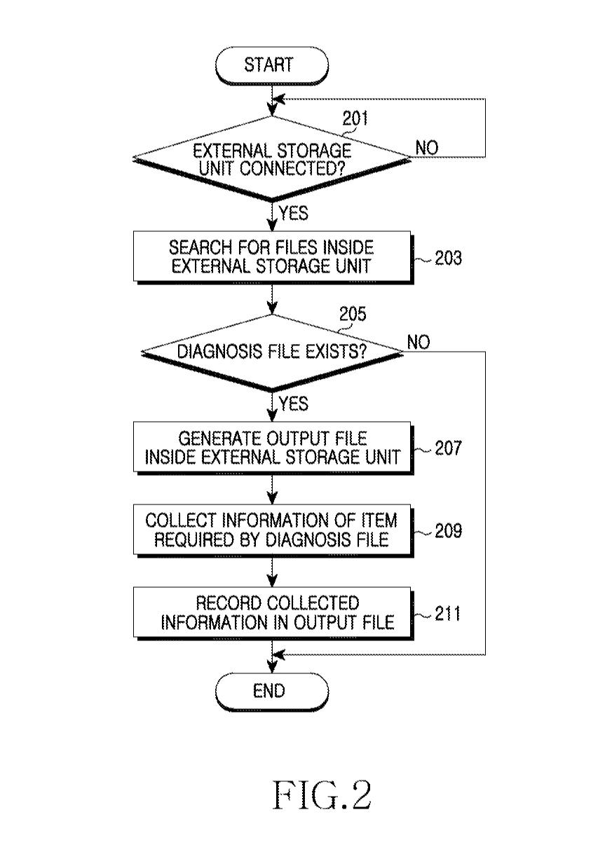

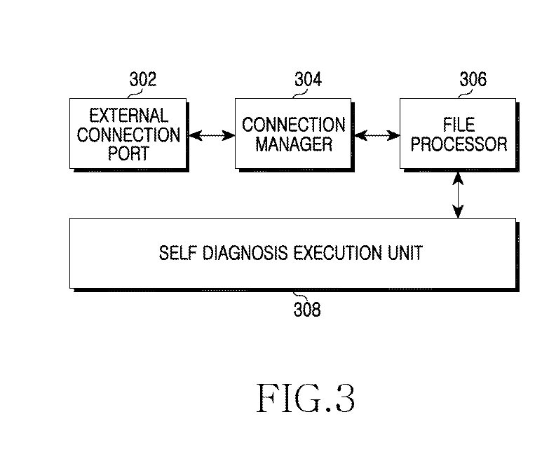

The operation and construction of digital equipment for performing the above-described self-diagnosis function are described in more detail with reference to FIGS. 2 and 3.

FIG. 2 is a flowchart illustrating a self-diagnosis procedure in digital equipment according to an exemplary embodiment of the present invention.

Referring to FIG. 2, the digital equipment may determine whether an external storage unit is connected in step 201. That is, the digital equipment may recognize physical connection of an external unit via an external connection port, and may determine if the connected external unit is a storage unit. For example, the external connection port may be a USB port.

When the external storage unit is connected, the digital equipment may search for files inside the external storage unit in step 203. That is, the digital equipment that has recognized the connection of the external storage unit, may configure a file system including the external storage unit, and may search for files stored inside the external storage unit. In other words, the digital equipment may determine names, capacities, and types of files stored inside the external storage unit.

The digital equipment may determine whether a diagnosis file for self diagnosis exists inside the external storage unit in step 205. For example, the diagnosis file may be identified using a filename. When the diagnosis file does not exist, the digital equipment may end the present procedure. In contrast, when the diagnosis file exists, the digital equipment may call a hook function, and may perform subsequent steps 207 to 211 according to the hook function.

When the diagnosis file exists, the digital equipment may generate an output file inside the external storage unit in step 207. That is, the digital equipment may generate the output file for storing results of the diagnosis. At this point, the digital equipment may set an output for recording the result of the diagnosis as the file output.

After generating the output file, the digital equipment may collect information regarding an item required by the diagnosis file in step 209. For example, the item may include at least one of a hardware version, a firmware version, a software version, a hardware device status, a function status, system statistics, alarm information, log information, operation history, debug information, etc.

After collecting the information, the digital equipment may record the collected information in the output file in step 211. At this point, the recording of the information may be performed according to a predefined format. When the recording of the information is completed, the digital equipment may close the output file.

FIG. 3 is a block diagram illustrating digital equipment according to an exemplary embodiment of the present invention.

Referring to FIG. 3, the digital equipment may include an external connection port 302, a connection manager 304, a file processor 306, and a self diagnosis execution unit 308. While the digital equipment may include other components, a description of any other components is omitted for conciseness.

The external connection port 302 denotes a port for connection of an external unit, and may be physically connected with the external unit. Therefore, the external connection port 302 may provide at least one of a data path, a control signal path, and a power providing path. For example, the external connection port 302 may be a USB port.

The connection manger 304 may manage connection of the external connection port 302. That is, the connection manger 304 may recognize connection of the external unit via the external connection port 302, and may maintain the connection. In addition, when the external storage unit is connected, the connection manger 304 may inform the file processor 306 of the connection of the external storage unit.

The file processor 306 may manage files stored in the digital equipment and the external storage unit. That is, the file processor 306 may configure a file system for the digital equipment and the external storage unit, and may process file generation and file loading. More particularly, when the external storage unit is connected, the file processor 306 may search for files stored in the external storage unit, that is, file processor 306 may determine information such as names, capacities, types, and the like of the files stored in the external storage unit. At this point, when a diagnosis file for self diagnosis is stored in the external storage unit, the file processor 306 may trigger an operation of the self diagnosis execution unit 308. In addition, the file processor 306 may generate an output file in the external storage unit, and may record information provided by the self diagnosis execution unit 308 in the output file.

The self diagnosis execution unit 308 may perform self diagnosis upon input of the diagnosis file via the external storage unit. At this point, the operation of the self diagnosis execution unit 308 may be performed as a hook function without a separate command. That is, the self diagnosis execution unit 308 may receive the diagnosis file from the file manager 306, and may collect information of an item required by the diagnosis file. For example, the item may include at least one of a hardware version, a firmware version, a software version, a hardware device status, a function status, system statistics, alarm information, log information, operation history, debug information, etc. In addition, the self diagnosis execution unit 308 may provide the collected information to the file manager 306.

The digital equipment may provide a self diagnosis function that is automatically performed and uses an external storage unit, so that system diagnosis may be performed promptly and accurately regardless of a user's familiarity of a malfunction diagnosis function.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating digital equipment that is connectable to an external storage unit, the method comprising:
searching for a diagnosis file for self diagnosis stored in the external storage unit when the external storage unit is connected to the digital equipment;
if the diagnosis file is found in the external storage unit, collecting information of at least one item required by the diagnosis file; and
storing the collected information as an output file in the external storage unit.

2. The method of claim 1, wherein the external storage unit is connected via a Universal Serial Bus (USB) port.

3. The method of claim 1, wherein the storing of the collected information comprises:
generating the output file in the external storage unit; and
recording the collected information in the output file.

4. The method of claim 1, wherein the storing of the collected information comprises:
generating the output file in an internal storage unit of the digital equipment;
recording the collected information in the output file; and
transmitting the output file to the external storage unit.

5. The method of claim 1, wherein the diagnosis file is searched for based on a filename.

6. The method of claim 1, wherein the at least one item comprises at least one of a hardware version, a firmware version, a software version, a hardware device status, a function status, system statistics, alarm information, log information, operation history, and debug information.

7. The method of claim 1, wherein the searching for the diagnosis file for self diagnosis stored in the external storage unit when the external storage unit is connected to the digital equipment comprises:
determining if the external storage unit is connected to the digital equipment; and
if the external storage unit is determined to be connected to the digital equipment, searching for the diagnosis file for self diagnosis stored in the external storage.

8. An apparatus for digital equipment that is connectable to an external storage unit, the apparatus comprising:
a processor for searching for a diagnosis file for self diagnosis stored in the external storage unit when the external storage unit is connected; and
an execution unit for, when the diagnosis file is found in the external storage unit, collecting information for at least one item required by the diagnosis file,
wherein the processor stores the collected information as an output file in the external storage unit.

9. The apparatus of claim 8, wherein the external storage unit is connected via a Universal Serial Bus (USB) port.

10. The apparatus of claim 8, wherein the processor generates the output file in the external storage unit and records the collected information in the output file.

11. The apparatus of claim 8, wherein the processor generates the output file in an internal storage unit of the digital equipment, records the collected information in the output file, and transmits the output file to the external storage unit.

12. The apparatus of claim 8, wherein the diagnosis file is searched for based on a filename.

13. The apparatus of claim 8, wherein the at least one item comprises at least one of a hardware version, a firmware version, a software version, a hardware device status, a function status, system statistics, alarm information, log information, operation history, and debug information.

14. The apparatus of claim 8, wherein the processor performs the searching for the diagnosis file for self diagnosis stored in the external storage unit when the processor determines that the external storage unit is connected to the digital equipment.

15. A digital equipment apparatus, the apparatus comprising:
an external connection port for connecting to an external storage unit;
a connection manager for determining if an external storage unit is connected to the external connection port, and if the connection manager determines that an external storage unit is connected to the external connection port, for informing a file processor that the external storage unit is connected to the external connection port;
the file processor, when being informed by the connection manager that the external storage unit is connected to the external connection port, for searching for a diagnosis file stored in the external storage unit, when the diagnosis file is found in the external storage unit, for sending the diagnosis file to a self diagnosis execution unit, for generating an output file, and for recording information provided by the self diagnosis execution unit in the output file; and
the self diagnosis execution unit for performing self diagnosis of the apparatus based on the diagnosis file received from the file processor, collecting information resulting from the self diagnosis of the apparatus, and providing the collected information to the file manager.

16. The apparatus of claim 15, wherein the external connection port comprises a Universal Serial Bus (USB) port.

17. The apparatus of claim 15, wherein the file processor generates the output file in the external storage unit.

18. The apparatus of claim 15, wherein the processor generates the output file in an internal storage unit of the apparatus and transmits the output file to the external storage unit via the external connection port.

19. The apparatus of claim 15, wherein the diagnosis file is searched for based on a filename.

20. The apparatus of claim 15, wherein the information comprises at least one of a hardware version, a firmware version, a software version, a hardware device status, a function status, system statistics, alarm information, log information, operation history, and debug information.
